(19) United States
(12) Patent Application Publication
(10) Pub. No.: US 2020/0094699 A1
(43) Pub. Date: Mar. 26, 2020

(54) VERTICAL CIRCULATION CHARGING PILE STRUCTURE FOR STEREO GARAGE

(71) Applicant: JIANGNAN UNIVERSITY, Jiangsu (CN)

(72) Inventors: Feng CHENG, Jiangsu (CN); Weixi JI, Jiangsu (CN); Hongyan JIANG, Jiangsu (CN)

(73) Assignee: JIANGNAN UNIVERSITY, Jiangsu (CN)

(21) Appl. No.: 16/086,014

(22) PCT Filed: Dec. 8, 2017
(86) PCT No.: PCT/CN2017/115182

§ 371 Date: Sep. 18, 2018

(30) Foreign Application Priority Data
Aug. 16, 2017 (CN) 201710700546.1

(51) Int. Cl. B60L 53/31; B60L 53/14; E04H 6/14

(52) U.S. Cl. CPC B60L 53/31; E04H 6/14; B60L 53/14

(57) ABSTRACT

A vertical circulation charging pile structure for stereo garage includes a parking garage workstation, a foundation, a pillar frame member fixed to the foundation, a deceleration motor and transmission member, a sprocket and link member, a car carrying frame member, a charging pile, a flexible charging wire, a charging interface socket, a charging interface plug provided at a top center of the foundation, and an electric push rod provided below the charging interface plug and communicated with the parking garage workstation. The pillar frame member is provided with the deceleration motor and transmission member. During power-on, the deceleration motor and transmission member drives rotation of the sprocket and link member synchronously rotation of a plurality of car carrying frame members. Each car carrying frame members is provided with one charging pile and one charging interface socket. Adjacent two charging piles are communicated by flexible charging wires.

### TECHNICAL FIELD OF THE INVENTION

The present invention relates to a novel structural design for an electric car charging pile, and in particular, to a vertical circulation charging pile structure for a stereo garage.

### BACKGROUND

With rapid development of the economy, number of electric vehicles in urban areas is increasing. At the same time, development of urban public services cannot keep up with development of current situation, public parking lot is restricted to supply of the public land, growth rate of the public parking lot is much lower than that of the number of cars, and the “hard-to-park” problem in public areas becomes more and more serious.

Currently, a wide variety of stereo garages emerge in the market, such as lift-sliding, laneway-stacking, vertical circulation and cylindrical tower types of stereo garages. The vertical circulation stereo garage is featured by small floor space, flexible arrangement, small site constraints, high spatial utilization ratio, single equipment power, simple operation, and low failure rate, so that parking and taking of the vehicle can be completed by one-time transfer, and that the vertical circulation stereo garage is suitable for group installation and construction of large-scale public parking lots. However, the vertical circulation stereo garage is merely adapted for fuel vehicles. In terms of electric vehicles that are currently popular in the city and that have a higher charging frequency, the vertical circulation stereo garage seems to be helpless under requirement of the electric vehicles needed to be charged after being parked. Since charging pile and electric circuit cannot be installed and implemented on the vertical circulation stereo garage, a vertical circulation stereo garage with a charging pile structure is not available in the current market.

### SUMMARY

### Technical Problem

In order to overcome the defect that the existing vertical circulation stereo garage cannot perform charging, the present invention provides a vertical circulation charging pile structure for stereo garage.

### Technical Solution

Technical solutions adopted by the present invention are as follows. A vertical circulation charging pile structure for a stereo garage, mainly including:

A parking garage workstation, a foundation, a pillar frame member, a deceleration motor and transmission member, a sprocket and link member, a car carrying frame member, a charging pile, a flexible charging wire, a charging interface socket, a charging interface plug and an electric push rod. The pillar frame member is fixed to the foundation. The pillar frame member is provided with the deceleration motor and transmission member. Upon power on, the deceleration motor and transmission member drive the sprocket and link member to rotate and brings a plurality of car carrying frame members to synchronously rotate. Each of the car carrying frame members is provided with one charging pile and one charging interface socket. Adjacent two charging piles are communicated by flexible charging wires in parallel connection. The charging interface plug is provided at a top center of the foundation. The electric push rod is provided below the charging interface plug. The electric push rod is communicated with the parking garage workstation.

Preferably, the charging piles are arranged in parallel connection. All the charging piles perform synchronous rotation and circulation movement along with a car carrying board. When the vehicle is parked in place and the parking garage workstation supplies power to any of the charging piles, the remaining charging piles are powered on at the same time, thereby ensuring all parking spaces are charged smoothly.

Preferably, number of the charging interface plug and number of the charging interface socket are in a one-to-many correspondence. The charging interface plug is movable. When an action of parking or taking a car is performed, the charging interface plug moves downwards under an action of the electric push rod, so as to allow the charging interface plug to disengage from the charging interface socket, and the charging pile is power-off and rotate synchronously along with the car carrying board. When the action of parking or taking a car is completed, the charging interface plug moves upwards under the action of the electric push rod, so as to allow the charging interface plug to connect with the charging interface socket, and all the charging piles is power-on.

### Beneficial Effect

The vertical circulation charging pile structure used for a stereo garage according to the present invention has advantages of simple and convenient charging and discharging, flexible arrangement and small occupation of land space, is capable of parking not only fuel vehicles but also electric vehicles that need to be recharged, and parking many vehicles, and thereby accommodating demands on charging function of a modern parking lot.

### BRIEF DESCRIPTION OF THE DRAWINGS

FIG. 1 is a structural diagram of a vertical circulation charging pile for a stereo garage; and

FIG. 2 is a circuit diagram of a vertical circulation charging pile for a stereo garage.

### DESCRIPTION OF THE REFERENCE NUMERALS

1. pillar frame member; 2-1. first charging pile; 2-2. second charging pile;

2-3. third charging pile; 2-4. fourth charging pile; 2-5. fifth charging pile; 2-6. sixth charging pile; 2-7. seventh charging pile; 2-8. eighth charging pile; 2-9. ninth charging pile; 2-10. tenth charging pile; 2-11. eleventh charging pile; 2-12. twelfth charging pile; 2-13. thirteenth charging pile; 2-14. fourteenth charging pile; 3. deceleration motor and transmission member; 4. sprocket and link member; 5-1. first charging interface socket;

5-2. second charging interface socket; 5-3. third charging interface socket; 5-4. fourth charging interface socket; 5-5. fifth charging interface socket; 5-6. sixth charging interface socket; 5-7. seventh charging interface socket; 5-8. eighth charging interface socket; 5-9. ninth charging interface socket; 5-10. tenth charging interface socket; 5-11. eleventh charging interface socket; 5-12. twelfth charging interface socket; 5-13.

thirteenth charging interface socket; 5-14. fourteenth charging interface socket; 6-1. first car carrying frame member; 6-2. second car carrying frame member; 6-3. third car carrying frame member; 6-4. fourth car carrying frame member; 6-5. fifth car carrying frame member; 6-6. sixth car carrying frame member; 6-7. seventh car carrying frame member; 6-8. eighth car carrying frame member; 6-9. ninth car carrying frame member; 6-10. tenth car carrying frame member; 6-11. eleventh car carrying frame member; 6-12. twelfth car carrying frame member; 6-13. thirteenth car carrying frame member; 6-14. fourteenth car carrying frame member; 7. flexible charging wire; 7-1. first flexible charging wire; 7-2. second flexible charging wire; 7-3. third flexible charging wire; 7-4.

fourth flexible charging wire; 7-5. fifth flexible charging wire; 7-6. sixth flexible charging wire; 7-7. seventh flexible charging wire; 7-8. eighth flexible charging wire 7-9. ninth flexible charging wire; 7-10. tenth flexible charging wire; 7-11. eleventh flexible charging wire; 7-12. twelfth flexible charging wire; 7-13. thirteenth flexible charging wire; 7-14. fourteenth flexible charging wire; 8. parking garage workstation; 9. electric push rod; 10. charging interface plug; 11. foundation.

### DETAILED DESCRIPTION OF THE INVENTION

The present invention will be described in detail with reference to the accompanying drawings and specific embodiments.

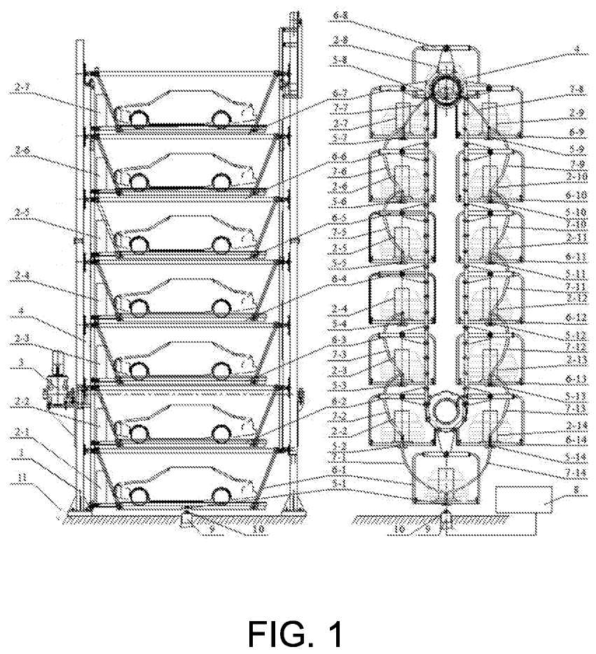

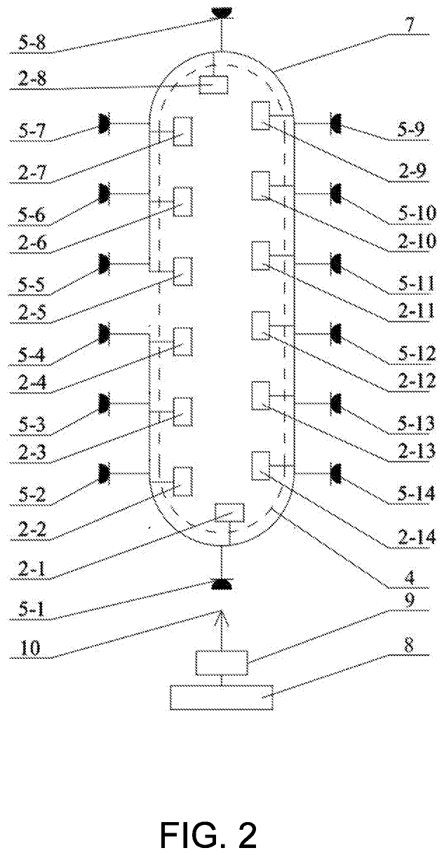

As shown in FIG. 1 and FIG. 2, a pillar frame member 1 is fixed on the foundation 11. The pillar frame member 1 is provided with a deceleration motor and transmission member 3, and a sprocket and link member 4. Fourteen car carrying frame members are uniformly distributed in a circumferential direction of the sprocket and link member 4, which sequentially are a first car carrying frame member 6-1, a second car carrying frame member 6-2, a third car carrying frame member 6-3, a fourth car carrying frame member 6-4, a fifth car carrying frame member 6-5, a sixth car carrying frame member 6-6, a seventh car carrying frame member 6-7, an eighth car carrying frame member 6-8, a ninth car carrying frame member 6-9, a tenth car carrying frame member 6-10, a eleventh car carrying frame member 6-11, a twelfth car carrying frame member 6-12, a thirteenth car carrying frame member 6-13, and a fourteenth car carrying frame member 6-14. The first car carrying frame member 6-1 is provided with a first charging pile 2-1 and a first charging interface socket 5-1. The second car carrying frame member 6-2 is provided with a second charging pile 2-2 and a second charging interface socket 5-2. The third car carrying frame member 6-3 is provided with a third charging pile 2-3 and a third charging interface socket 5-3. The fourth car carrying frame member 6-4 is provided with a fourth charging pile 2-4 and a fourth charging interface socket 5-4. The fifth car carrying frame member 6-5 is provided with a fifth charging pile 2-5 and a fifth charging interface socket 5-5. The sixth car carrying frame member 6-6 is provided with a sixth charging pile 2-6 and a sixth charging interface socket 5-6. The seventh car carrying frame member 6-7 is provided with a seventh charging pile 2-7 and a seventh charging interface socket 5-7. The eighth car carrying frame member 6-8 is provided with an eighth charging pile 2-8 and an eighth charging interface socket 5-8. The ninth car carrying frame member 6-9 is provided with a ninth charging pile 2-9 and a ninth charging interface socket 5-9. The tenth car carrying frame member 6-10 is provided with a tenth charging pile 2-10 and a tenth charging interface socket 5-10. The eleventh car carrying frame member 6-11 is provided with an eleventh charging pile 2-11 and an eleventh charging interface socket 5-11. The twelfth car carrying frame member 6-12 is provided with a twelfth charging pile 2-12 and a twelfth charging interface socket 5-12. The thirteenth car carrying frame member 6-13 is provided with a thirteenth charging pile 2-13 and a thirteenth charging interface socket 5-13. The fourteenth car carrying frame member 6-14 is provided with a fourteenth charging pile 2-14 and a fourteenth charging interface socket 5-14. Adjacent charging piles are communicated by a flexible charging wire 7. The flexible charging wire 7 is composed of a first flexible charging wire 7-1, a second flexible charging wire 7-2, a third flexible charging wire 7-3, a fourth flexible charging wire 7-4, a fifth flexible charging wire 7-5, a sixth flexible charging wire 7-6, a seventh flexible charging wire 7-7, an eighth flexible charging wire 7-8, a ninth flexible charging wire 7-9, a tenth flexible charging wire 7-10, an eleventh flexible charging wire 7-11, a twelfth flexible charging wire 7-12, a thirteenth flexible charging wire 7-13, and a fourteenth flexible charging wire 7-14, which achieves parallel communication of all the charging piles. An electric push rod 9 is provided below a charging interface plug 10. The charging interface plug 10 and the electric push rod 9 are installed at a top center of the foundation 11, and are communicated with the parking garage workstation 8.

Working process of the vertical circulation charging pile for stereo garage is as follows. When a user takes a card to perform an action of parking or taking a car, as shown in FIG. 1, the parking garage workstation 8 issues a command, the electric push rod 9 starts to work to push the charging interface plug 10 to move downwards, so as to allow the charging interface plug 10 to disengage from the first charging interface socket 5-1, and the fourteen charging piles are power-off simultaneously. At the same time, the deceleration motor and transmission member 3 operates to drive the sprocket and link member 4 to move, and brings the fourteen car carrying frame members and the fourteen charging piles to synchronously rotate to parking-allowable positions. When the action of parking or taking a car is completed, the deceleration motor and transmission member 3 stops working, the fourteen car carrying frame members and the fourteen charging piles stop moving, the parking garage workstation 8 issues a command again, the electric push rod 9 works again to push the charging interface plug 10 to move upwards, so as to allow the charging interface plug 10 to connect with the right above charging interface socket 5-1, and the fourteen charging piles are power-on simultaneously.

It should be noted that persons skilled in the art can make various improvements and modifications without departing from the principle of the present invention, and these improvements and modifications should also be considered as the protection scope of the present invention. The components that are not clearly defined in this embodiment all can be implemented by the prior art.

1. A vertical circulation charging pile structure for a stereo garage, mainly comprising a parking garage workstation, a foundation, a pillar frame member, a deceleration motor and transmission member, a sprocket and link member, a car carrying frame member, a charging pile, a flexible charging wire, a charging interface socket, a charging interface plug, and an electric push rod; wherein, the pillar frame member is fixed to the foundation, the pillar frame member is provided with the deceleration motor and transmission member, upon power on, the deceleration motor and transmission member drives the sprocket and link member to rotate and brings a plurality of car carrying frame members to synchronously rotate; each of the car carrying frame members is provided with one charging pile and one charging interface socket, adjacent two charging piles are communicated by flexible charging wires in parallel connection, the charging interface plug is provided at a top center of the foundation, the electric push rod is provided below the charging interface plug, the electric push rod is communicated with the parking garage workstation.

2. The vertical circulation charging pile structure for a stereo garage according to claim 1, wherein number of the charging interface plug and number of the charging interface socket are in a one-to-many correspondence, the charging interface plug is movable; when an action of parking or taking a car is performed, the charging interface plug moves downwards under an action of the electric push rod, so as to allow the charging interface plug to disengage from the charging interface socket, and the charging pile is power-off, at the same time, the deceleration motor and transmission member operates to drive the sprocket and link member to move, and to bring the car carrying frame member and the charging pile to synchronously rotate to a parking-allowable position; when the action of parking or taking a car is completed, the charging interface plug moves upwards under the action of the electric push rod, so as to allow the charging interface plug to connect with the charging interface socket, and the charging pile is power-on for charging the car parked in the stereo garage.
